(19) United States
(12) Patent Application Publication
(10) Pub. No.: US 2002/0199179 A1
(43) Pub. Date: Dec. 26, 2002

(54) Method and apparatus for compiler-generated triggering of auxiliary codes

(76) Inventors: Daniel M. Lavery, Santa Clara, CA (US); Hong Wang, Fremont, CA (US); Gerolf F. Hoflehner, Santa Clara, CA (US); Shih-wei Liao, Sunnyvale, CA (US); John Shen, San Jose, CA (US); Edward T. Grochowski, San Jose, CA (US); David C. Sehr, Sunnyvale, CA (US); Jesse Z. Fang, San Jose, CA (US)

Correspondence Address: KENYON & KENYON, Suite 600, 333 W. San Carlos Street, San Jose, CA, 95110-2711, US

(21) Appl. No.: 09/886,585

(22) Filed: Jun. 21, 2001

(51) Int. Cl. G06F 9/45

(52) U.S. Cl. 717/158

(57) ABSTRACT

A method for executing a code is provided. The method includes receiving a trigger instruction, selecting an entry in a trigger table, the entry associated with the trigger instruction, and executing an auxiliary code referenced by the entry in the trigger table.

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND INFORMATION

For most programs, only a small number of static loads are responsible for the vast majority of cache misses. Research has shown that a few common static loads account for most cache misses in benchmark execution runs. See, e.g., Abraham, Santosh and Rau, B. Ramakrishnan, PREDICTING LOAD LATENCIES USING CACHE PROFILING, HP Labs Technical Reports, HPL-94-1 10, Dec. 6, 1994. The few static loads that are the dominant source of cache misses may be termed “delinquent loads”. Other long latency events may also be termed “delinquent” and result in system performance degradation, e.g., accessing peripherals, handling conditions that require special processing, emulating an instruction not actually provided in hardware, etc.

Previous work on code performance improvement has included compiler code optimization. Code optimization techniques include procedures for modifying code to change the order of execution or eliminate redundant instruction executions. See, e.g., Carole Dulong, et al, “An Overview of the Intel IA 64 Compiler”, INTEL TECHNOLOGY JOURNAL Q4, 1999. The techniques therein include procedures for using profile information from trial runs of program to guide optimization. The techniques described therein also include the insertion of prefetching instructions at strategic points in a program to insure that data items are moved as close to the processor as possible before the data items are actually used.

Hardware architectures provide hardware support for data prefetching have also been previously described. See, e.g., Jagannath Keshava and Vladimir Pentkovski, “Pentium III Processor Implementation Tradeoffs ”, INTEL TECHNOLOGY JOURNAL Q2, 1999.

### BRIEF DESCRIPTION OF THE DRAWINGS

FIG. 1 illustrates the execution of an example function with an auxiliary thread, according to an example embodiment of the present invention.

FIG. 2 illustrates an example method for executing an instruction in an example function, according to an example embodiment of the present invention.

FIG. 3 illustrates an example function, according to an example embodiment of the present invention.

FIG. 4 illustrates an example function body in an example function, according to an example embodiment of the present invention.

FIG. 5 illustrates an example auxiliary code in an example function, according to an example embodiment of the present invention.

FIG. 6 illustrates an example trigger table associated with an example function, according to an example embodiment of the present invention.

FIG. 7 illustrates an example procedure for compiling, according to an example embodiment of the present invention.

### DETAILED DECRIPTION

A first example embodiment of the present invention provides a method and apparatus for providing auxiliary computation. One example of auxiliary computation may be “speculative precomputation”. In auxiliary computation, an event may trigger the invocation and execution of an auxiliary code as a separate auxiliary thread. The auxiliary thread may execute concurrently with the original thread that triggered the invocation and execution of the auxiliary thread.

Auxiliary threads may be spawned when encountering a “basic trigger”, which may occur when a designated instruction in the non-auxiliary thread is processed, e.g., when the instruction is retired. Auxiliary threads may also be spawned by a “chaining trigger”, when one auxiliary code explicitly spawns another.

One example of an auxiliary code may be a “precomputation-slice” (or p-slice) executed as a “speculative thread”. A speculative thread may precompute and access memory addresses accessed by a delinquent load that is expected to appear later in the instruction stream. The speculative thread may be used to prefetch information, potentially eliminating the cache miss for the delinquent load.

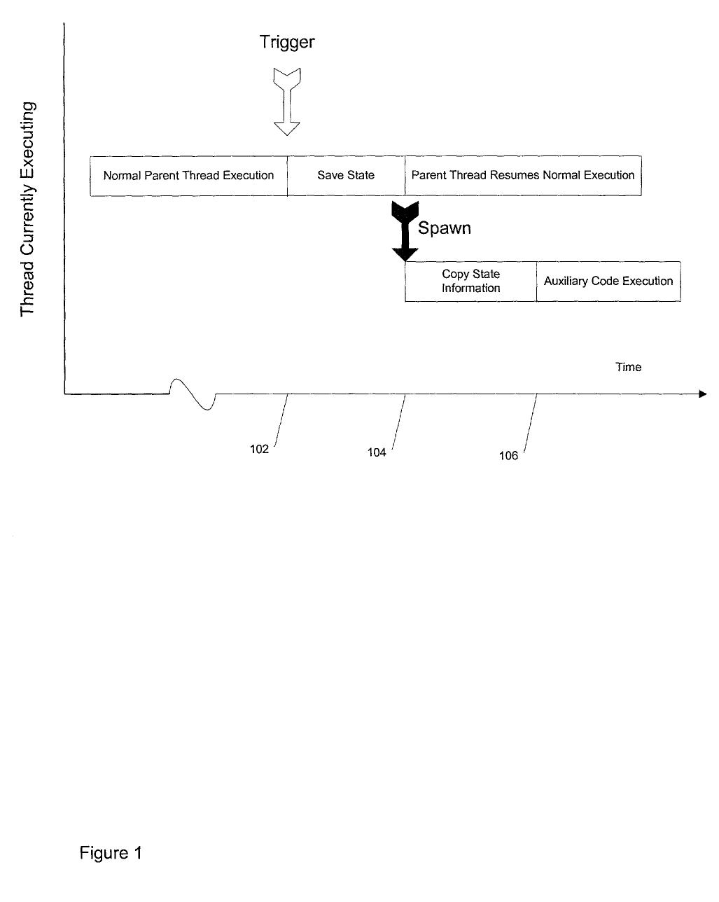

FIG. 1 illustrates the execution of an example function with an auxiliary thread, according to an example embodiment of the present invention. Initially, a “parent thread” executes normally. At time 102, a trigger occurs, e.g., when the parent thread receives an instruction that has been designated as a “trigger instruction”. Any type of instruction or subset of types of instructions may be treated as a trigger. Depending on the processor implementation, e.g., in a processor that uses associative lookup tables to interpret machine instructions, every instruction may be treated as a trigger instruction. After the trigger instruction has been received, the parent thread then may execute instructions found in an auxiliary code associated with the trigger instruction. The instructions in the auxiliary code may be provided explicitly by the user or may be generated by the compiler or other application. The auxiliary code may also be provided after the initial compilation, e.g., by a dynamic compiler that receives feedback regarding execution profiles of the original compiled function. The instructions in the auxiliary code may be duplicates of selected instructions in the original function. These duplicated instructions need not be contiguous or successive instructions in the original function.

The auxiliary code may be configured to include two parts, a stub and a body. The stub may include the instructions used to spawn an auxiliary thread. The body may include the instructions, which are to be executed by the auxiliary thread. Before spawning the auxiliary thread, the parent thread or “parent” thread may first save its state information, e.g., by copying the values contained in the parent thread's registers to a predetermined scratch memory location. The parent thread may also test various conditions, e.g., hardware state information.

At time 104, a new, auxiliary thread may be spawned. The auxiliary thread may be spawned by allocating a hardware thread context. If a free hardware thread context is not available, then the spawn request may be ignored, or alternatively the spawn request may be queued for later execution. The auxiliary thread may receive all or part of the parent thread's state information. For example, the state information may be provided by copying the register values, saved by the parent thread in step 102, into the auxiliary thread's context register file, and providing the auxiliary thread's context with the address of the first instruction of the auxiliary thread, e.g., the address of an instruction in the body of the auxiliary code.

The new, auxiliary thread may begin execution of instructions provided in the body of the auxiliary code at time 106. While the auxiliary thread executes, the parent thread may continue to execute concurrently with the auxiliary thread. It will be appreciated that whether individual instructions in the parent thread and the auxiliary thread are actually executed simultaneously may depend upon the particular architecture of the processor, e.g., the granularity of the parallelism allowed between concurrently executing threads. Alternatively, the parent thread may stall and wait for the completion of the auxiliary code by the auxiliary thread. Other execution schemes may also be provided, e.g., the parent thread might run in parallel until receiving a pre-specified signal, or wait until it receives a pre-specified signal from the auxiliary code and then resume execution in parallel.

Example Procedure for Executing an Instruction

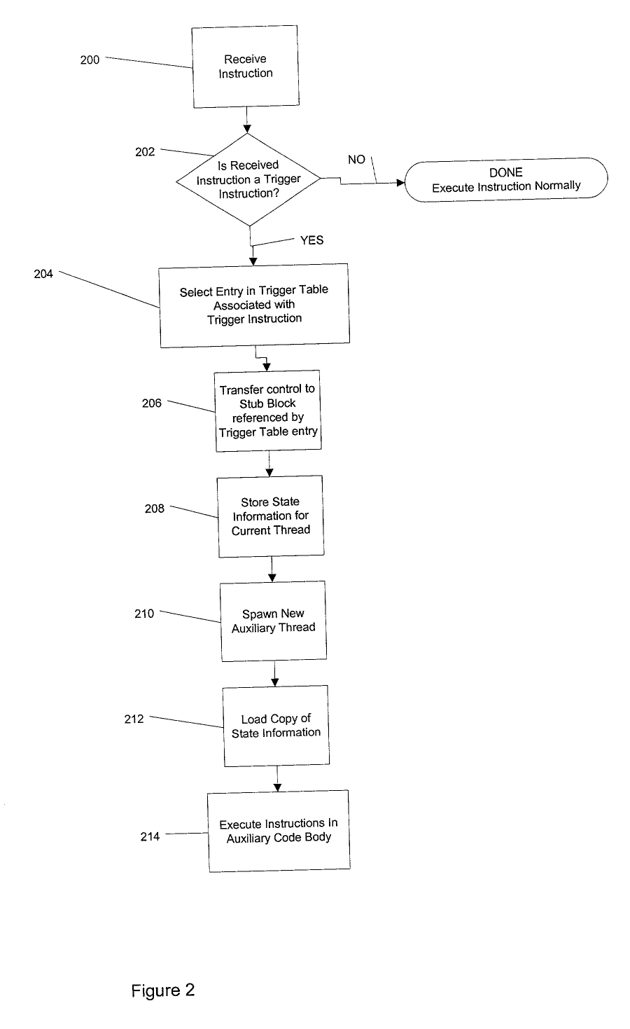

FIG. 2 illustrates an example procedure for executing an instruction in an example function, according to an example embodiment of the present invention. A copending application by Hong Wang et al, Software-Based Speculative Pre-Computation and MultiThreading, U.S. patent application Ser. No. 09/823,674, describes mechanisms to capture architectural and micro-architectural enhancements to a traditional multithread processor that may be used to generate and support the execution of speculative precomputation threads.

In step 200 an instruction may be received for execution by a processor. It will be appreciated that the exact sequence between the execution of the instruction by the processor as part of a normal thread and the completion of the rest of the steps of the example procedure may be varied. For example, the rest of the example procedure may completed at different points during the processing of the instruction: while the instruction is loaded, during the execution of the instruction, immediately after the execution of the instruction, or when the instruction is retired.

In step 202 the received instruction is tested to determine whether it is a trigger instruction. For example, this may be determined by looking in the trigger table to determine whether there is an entry corresponding to the received instruction. It will be appreciated that other mechanisms may be used to identify trigger instructions, e.g., some form of label may be included in the code for the instruction. In a system where instructions are interpreted into a microcode, the label might be included as part of the microcode for the instruction, e.g., as a special bitfield used as a tag or label. If the instruction is not a trigger instruction, the example procedure may be completed and the execution of the received instruction as part of a normal thread may be completed in the conventional fashion. If the instruction is a trigger instruction, the example procedure may continue with step 204.

In step 204, the entry for the trigger instruction in the trigger table may be selected. It may be appreciated that this step may be performed together with step 202 as a single step, depending on how the trigger table has been implemented. For example, an associative table may be provided that returns an entry if the trigger instruction is in the table, and provides a signal or other indication that the instruction is not a trigger instruction when there is not an entry in the table corresponding to the instruction.

In step 206, control may be transferred to the auxiliary code, which may be referenced by the entry in the trigger table that is associated with the trigger instruction. For example, the entry in the trigger table may contain an instruction pointer to the first instruction in the auxiliary code, and the current thread may execute that instruction.

In step 208, the state of the current thread may be saved. For example, the contents of the registers of the current thread may be copied to scratch memory. The auxiliary code that is associated with the trigger instruction may be analyzed, e.g., at compile time, to determine its “live-in” register values. Live-in registers are registers that are used by the auxiliary thread without having first been initialized or written to. Thus these registers are expected to contain information from the parent thread. Storing the values of the live-in registers and using copies of these values in the auxiliary thread may avoid the possibility of inter-thread hazards, where some register is overwritten in the parent thread before a child thread has read it.

In step 210, a new “auxiliary” thread may be spawned. The instructions for the new thread may be provided in the auxiliary code. When spawned, an auxiliary thread may occupy a hardware thread context until the auxiliary thread completes execution of all instructions in the auxiliary code. Auxiliary threads may be prevented from updating the architectural state. In particular, store instructions in an auxiliary code may be prevented from updating any memory state.

In step 212, the newly spawned auxiliary thread may load copies of the state information that was saved in step 208. For example, the necessary live-in register values may be copied into the auxiliary thread's context registers.

In step 214, the auxiliary thread may execute instructions that have been provided in an auxiliary code body. It will be appreciated that, depending on the implementation, the original thread may stall and wait for the completion of the auxiliary thread, or may continue to execute concurrently with the auxiliary thread. The auxiliary thread may execute until the auxiliary thread completes, dies, or receives a predefined signal to terminate. For example, the auxiliary thread may be configured so that a signal from the parent thread may cause the auxiliary thread to terminate.

It will be appreciated that the steps of the example procedure, described above, could be defined as a series of instructions adapted to be executed by a processor, and these instruction could be stored on a computer-readable medium, e.g., a tape, a disk, a CD-ROM, etc.

Example Function with Auxiliary Codes

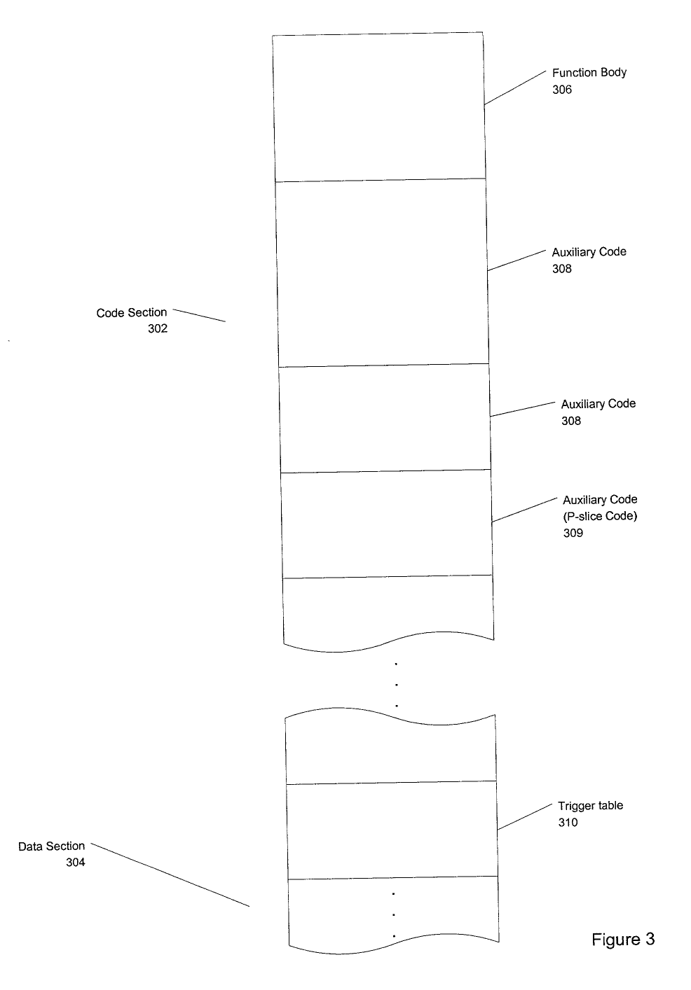

FIG. 3 illustrates an example function including instructions for generating an auxiliary thread, according to an example embodiment of the present invention.

The example function may include two parts: a code section 302 and a data section 304. The code section and data section may reside in the memory of a computer; the computers processor may execute the function. It will be appreciated that the code section 302 and the data section 304 need not be located at contiguous memory locations. It will also be appreciated that, in a system employing virtual memory or some other form of memory hierarchy, the instructions need not be all resident in memory at any given time.

The example code section 302 may include instructions that may be executed as part of the function. The instructions that are executed by the function during normal execution may be contained in the function body 306. These instructions may be assembly language or higher-level language instructions, microcode, or binary machine instructions.

The code section 302 may also include one or more auxiliary codes 308. An auxiliary code 308 may contain the instructions needed to spawn and execute an auxiliary thread. It will be appreciated that, depending on the architecture of the compiler and linker, the auxiliary codes may also be contained in separate code or text sections. The code section may also include an auxiliary code 309 which is a p-slice that is configured to be executed as a speculative thread when the corresponding trigger instruction is processed. The auxiliary code used as a p-slice may have the same basic structure as an ordinary auxiliary code. It will be appreciated that a system may provided that only uses auxiliary codes for providing speculative computation using p-slices. However, as shown in FIG. 3, both auxiliary codes that are p-slice codes and auxiliary codes that are not p-slice codes may be provided. It will also be appreciated that the code section 302 may also include other elements. For example, depending on the compiler and linker architecture, a single code section may include multiple function body and auxiliary codes. The code section may also include other fields or sections that are used in the compilation or execution of the function.

The example function may also include a data section 304 associated with the function. The data section 304 may include storage space for use in the function, e.g., for static variables.

The data section may also include a trigger table 310, The trigger table 310 may be used to identify trigger points in the function that may trigger an auxiliary thread. The trigger table 310 may also include information for identifying the auxiliary code associated with the trigger, The trigger table may include references to instructions to be executed to spawn the auxiliary thread and references to instructions which are configured to be executed by the auxiliary thread.

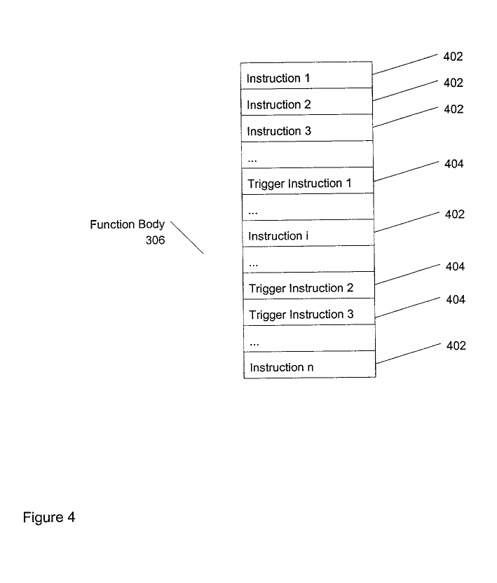

FIG. 4 illustrates an example function body 306 in an example function, according to an example embodiment of the present invention. The function body 306 may include instructions 402. Some instructions 404 may be “trigger instructions”. These trigger instructions may be identified by expressly including in the function body a label or a tag that identifies an instruction as a trigger instruction, e.g., by including tag bits in the op-code for the instruction. Alternatively, the instruction itself may be used as the tag or label, e.g., by table lookup of the opcode for the instruction. A further alternative is to provide the compiler with a list of the addresses or positions in the function body where trigger instructions are located in the body.

It will be appreciated that any instruction in a function body may potentially be a trigger instruction, and that the trigger instructions need not be at any particular location in the function body, e.g., the trigger instructions and instructions that are not trigger instructions may be intermingled in the function body.

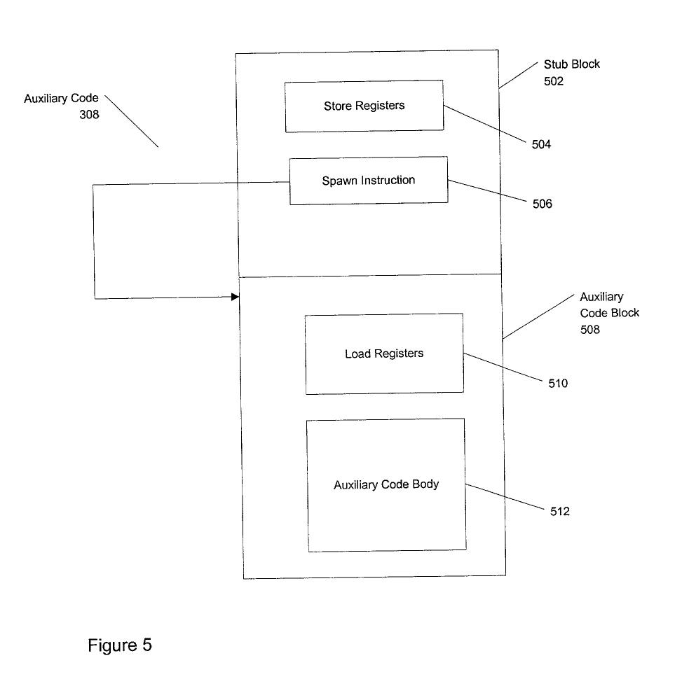

FIG. 5 illustrates an example auxiliary code 308 in an example function, according to an example embodiment of the present invention. An auxiliary code 308 may include a set of instructions located in the text section of the function. The example auxiliary code 308 may include two components: a stub block 502 and an auxiliary code block 568. The stub block 502 and the auxiliary code block 508 (auxcodeblock) may be “basic blocks” for compilation purposes.

The stub block 502 may contain a state saving mechanism 504. The state saving mechanism may include instructions to copy the live-out registers from the parent thread's register file to a scratch memory area. The saved state information may be accessed by the spawned auxiliary thread. It will be appreciated that other state information may be saved, e.g., microarchitecture state or other state information.

The stub block 502 may also contain a spawn instruction 506, i.e., an instruction to spawn the auxiliary thread. The spawn instruction may include the address of the instructions to be executed by the auxiliary thread. This address may also be obtained by associative lookup of the spawn instruction in the trigger table. When the auxiliary thread is spawned, the auxiliary thread may begin executing the instructions in auxiliary code block 508. The auxiliary code block 508 may contain instructions to read state information from the patent thread, e.g., copying live-in register values from the scratch memory area to the auxiliary thread's context register file. The auxiliary code block 508 may also contain the instructions for the body of the auxiliary code.

It will be appreciated that other instructions may be included in the stub block 502. For example, the stub block 502 may include tests of hardware state, microarchitecture state, or other conditions, and may also include conditional statements. For example, the stub block 502 may include instructions that prevent the spawning of the auxiliary thread if certain conditions are present, e.g., if no hardware thread contexts are available. The stub block 502 may also reference different instruction based on the conditions that are present, i.e., a different starting address may be used to spawn the new auxiliary thread depending on the state of the parent thread and of the system as a whole.

The auxiliary code block 508 may include a state loading mechanism, for example instructions to lead registers 510. The load registers instructions 510 may copy the state information saved by the parent thread which spawned the auxiliary thread. Information that was saved by the state saving mechanism instructions in 504 may be retrieved and copied into the register context file for the auxiliary thread. It will be appreciated that other state information may be loaded, e.g. microarchitecture state information or other hardware state information.

The auxiliary code block 508 may also include an auxiliary code body 512. The auxiliary code body 512 may contain instructions that may be executed by the auxiliary thread.

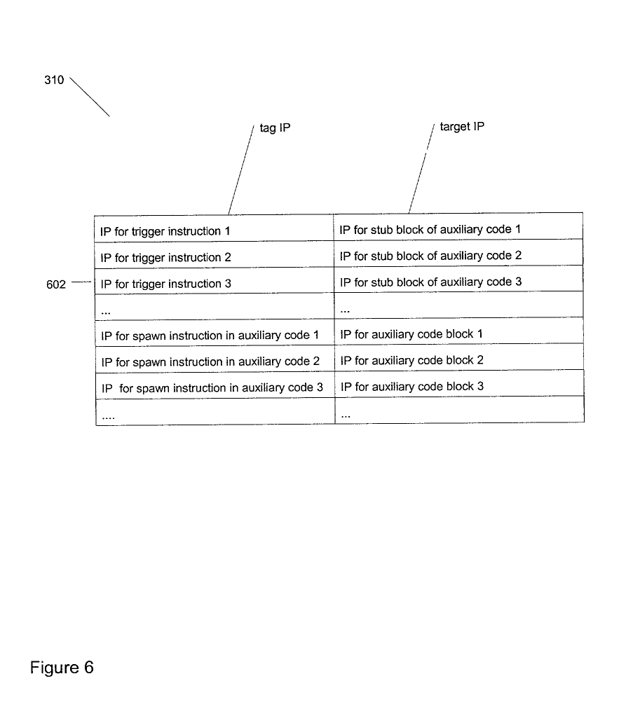

FIG. 6 illustrates an example trigger table 310 associated with the example function, according to an example embodiment of the present invention. The trigger table 310 may include entries 602. Each entry in the trigger table 310 may include two fields. The first field may be a “tag”, e.g., the instruction pointer of an instruction that may be associatively looked up in the table. The second field may be a “target”, e.g., the address of an instruction that is associated with the tag instruction.

The example trigger table 310 may contain two types of entries, “stub” entries and “auxiliary code entries”. A stub entry may include the instruction pointer for a trigger instruction in the function body as the stub entry's tag field. The stub entry's target field is the address of the first instruction of the stub block of the auxiliary code associated with the trigger instruction. An auxiliary code entry may include the address of the spawn instruction in a stub as the auxiliary code entry's tag field. The auxiliary code entry's target field may be the instruction pointer address of the first instruction in the corresponding auxiliary code block.

The trigger table may be configured to allow associative lookup of the entry with a particular tag, for example by loading the trigger table into a hardware structure that allows fast associative lookups. It will be appreciated that other conventional methods of organizing the table may be used, e.g., a hash table, the use of explicit links, etc.

It will be appreciated that the trigger table may be structured in other ways. For example, stub entries and auxiliary code entries may be stored in separate trigger tables. Entries may have additional fields. Other methods of lookup and association may also be used. For example, a trigger table may be provided for associative lookup of trigger instructions by name, instead of by address. Any conventional mechanism for selecting the entry in the trigger table that corresponds to a particular trigger instruction in the function body may be used, e.g., a hash table.

Compiler Support

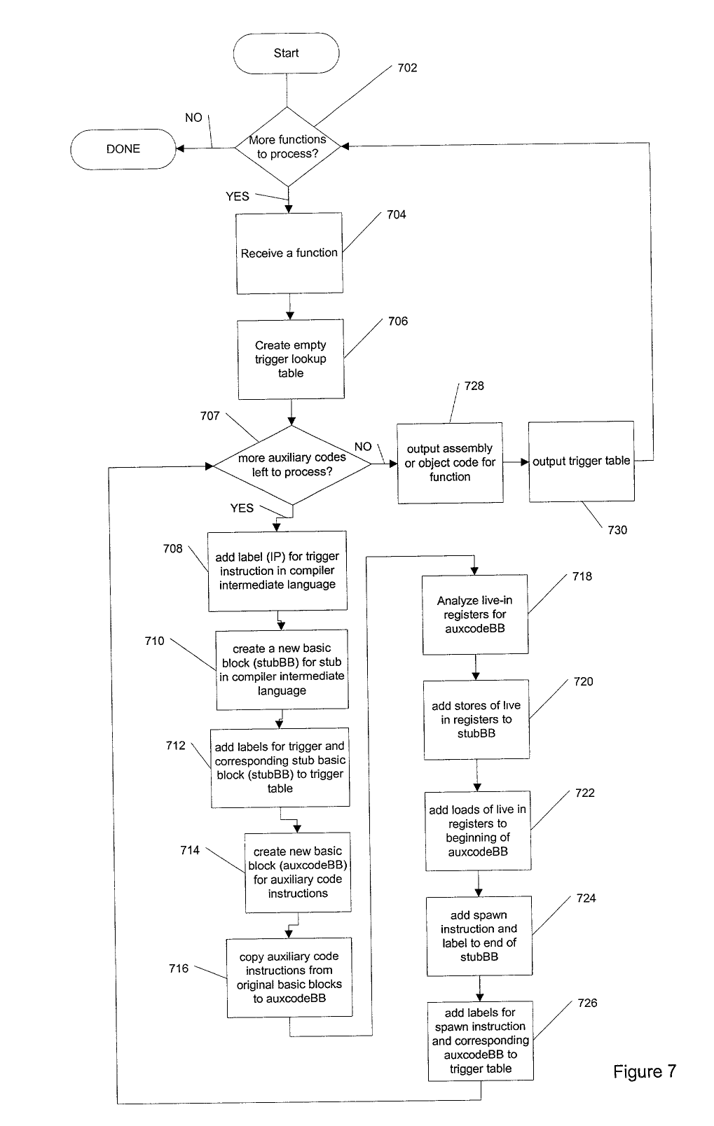

FIG. 7 illustrates an example procedure for compiling, according to an example embodiment of the present invention. The example procedure illustrated in FIG. 7 may be carried out by a compiler, or by other tools in a computing environment. The compiler may receive a computer program including one or more functions. The computer program may be a binary, or a code in an intermediate language (IL). For each function in the code, trigger instructions may be designated. The trigger instruction may be designated by any conventional mechanism that allows the trigger instructions to be identified and located by the compiler, e.g., a list of the locations in the received code that are trigger instructions may be supplied, or a label or tag may be included with each trigger instruction. The trigger instruction designations may be made manually, provided by another system utility, or created by the compiler through structural analysis of the code. It may desirable for the compiler, using its own analysis or feedback from runtime analysis to be able to insert a mechanism into a binary executable code for triggering the auxiliary codes. The triggering mechanism may be added during the compilation process or the post-link time binary translation.

In step 702, the example procedure may determine whether there are additional functions to process using the example compilation procedure. If there are no additional functions to process, the example procedure may terminate. Otherwise, the example procedure may continue with step 704.

In step 704, the example procedure may receive a function. This function may include a designation of which instructions in the function body are trigger instructions. The example procedure may also receive auxiliary codes, or other designations of instructions to be executed in an auxiliary code, as well as information associating the trigger instructions for the function with the auxiliary codes.

In step 706, the example procedure may create an empty trigger table for the function.

In step 707, the example procedure may determine whether all the auxiliary codes associated with the current function have been processed. If there are auxiliary codes left to process for the current function, the example procedure may continue with step 708. Otherwise, the example procedure may continue with step 728.

In step 708, a label may be added to the received function to allow the compiler to recognize the trigger instruction. For example, the label may be an instruction pointer (IP) for the trigger instruction. This label might be added directly to the trigger instruction in an intermediate language code for the function body.

In step 710, the example procedure may create a stub block corresponding to the trigger instruction (denoted here stubBB). The stub block may be a compiler basic block in the compiler's intermediate language. The stub block may be configured to contain instructions for spawning the auxiliary thread that will execute the auxiliary code instructions.

In step 712, an entry in the trigger table for the current auxiliary code may be created. The entry may include the label or address for the trigger instruction, and a reference to stubBB, the basic block created in step 710, for example the instruction pointer address for the first instruction in stub block.

In step 714, a new basic block for the auxiliary code may be created, denoted auxxcode BB in the figure. This basic block may contain the auxiliary code body.

In step 716, the original, received auxiliary code instructions may be copied into auxcodeBB, the basic block that was created for the auxiliary code in step 714. Instructions may be copied from the basic block in the originally received code for the function.

In step 718, the auxiliary code may be analyzed to identify the live-in registers for the auxiliary code. These live-in registers may include registers that are read or used in the auxiliary code block without being defined or written before their use. These live-in registers may contain state information that must be copied from the parent thread.

It will be appreciated that a conservative structural analysis may be used; registers that may be live in only if certain conditions are met may be conservatively classified as live in.

In step 720, instructions may be added to the stub block basic block (stubBB) to save values of the live-in registers to scratch memory locations.

In step 722, instructions may be added to the auxiliary code body (auxcodeBB). These instructions may load the saved values of the live-in registers for the auxiliary code body. For example, registers may be allocated to the auxiliary thread at compile time. Instructions may be added which load saved values from scratch memory into these allocated registers. These saved values may be live-in register values.

In step 724, a spawn instruction may be added to the stub block basic block (stubBB). A label may also be added to the spawn instruction to allow it to be identified.

In step 726, entries may be added to the trigger table. The entries may contain the label or address for the spawn instruction, and the label or address for the basic block containing the corresponding auxiliary code block (auxcodeBB).

In step 728, there are no more auxiliary codes to process in the current function. The example procedure may output the assembly or object code instructions for the compiled function. Assembly or object code instructions for the auxiliary codes associated with the function may also be output.

In step 730, the trigger table may be output as part of the data section for the compiled function. It will be appreciated that other arrangements of the trigger table may be employed, e.g., the trigger table might be output separately, or in a different location, as long as the location followed some known, consistently-used convention. The example procedure may then continue with step 702.

It will be appreciated that the steps of the compilation procedure, described above, could be defined as a series of instructions adapted to be executed by a processor, and these instruction could be stored on a computer-readable medium, e.g., a tape, a disk, a CD-ROM, etc.

Second Example Embodiment

According to a second example embodiment of the present invention, a procedure may be provided to place auxiliary code “optimally” with respect to the original binary code of the function body. The auxiliary code may be located in memory so that concurrent fetch operations in the original function body binary and the auxiliary code will not cause cache bank conflicts or cache line conflict misses.

In the second example embodiment, the compiler may include techniques similar to branch alignment optimization. See, e.g., Cliff Young, Nicolas Gloy, and Michael D. Smith, “A Comparative Analysis of Schemes for Correlated Branch Prediction”, Proc. 22nd Annual Intl. Symp. on Computer Architecture, June 1995. The example compiler may also include a continuous recompilation module. This continuous recomputation module may receive alignment profile information, e.g., from a real time monitoring mechanism. The example compiler may then re-map the auxiliary code map memory layout. Alternatively, hardware-monitoring information, e.g., from a hardware-assisted discrete pipeline event trace monitor, may be used by a dynamic optimizer to re-map the auxiliary code memory layout.

Third Example Embodiment

According to a third example embodiment of the present invention, profile results that identify a set of delinquent operations for a given binary can be fed back to a continuous compiler or dynamic optimizer so that the compiler can re-analyze the data flow of the program instructions leading up to the delinquent load, discover auxiliary codes, and optimize trigger placement.

Fourth Example Embodiment

According to a fourth example embodiment of the present invention, profile results that identify and produce auxiliary code instruction sequences for a set of delinquent operations in an original binary code may be fed back to a continuous compiler or dynamic optimizer. The compiler, linker or loader may place or package these instruction sequences in a location associated with the original binary.

In a system with tight-coupling, the auxiliary code instructions may be packaged in the same binary as the original code.

In a system with loose coupling, the auxiliary code instruction sequences may be packaged in a DLL (dynamic linked library) or similar mechanism. It will be appreciated that packaging the auxiliary code instructions in a DLL-like mechanism may allow changes to be made outside the original binary, while retaining the DLL label or thunks in the original binary.

Fifth Example Embodiment

In a fifth example embodiment according to the present invention, profile-based optimizations may be applied during different phases of compilation. For example, in late phases of the compiler for the Intel® Itanium™ processor, described in the Dulong reference cited previously, there is a 1-to-1 mapping between the intermediate language instructions and instruction in the assembly code produced by the compiler. It will be appreciated that, in this situation, trigger placement and related optimizations can be done at the code generation phase of the compiler. Optimization at other phases may be possible by mapping feedback information related to the binary or assembly language code or binary back to original code that was provided to the compiler.

Sixth Example Embodiment

In a sixth example embodiment of the present invention, an instruction sequence may be “templatized” by packing the instruction sequence into an EPIC (explicitly parallel instruction computing) or VLIW (very long instruction word) instruction packet form. Packetizing the instruction may make the auxiliary code readily executable on a canonical EPIC or VLIW pipeline hardware, without having to assume new microarchitecture that is specifically designed to execute auxiliary code instructions.

Multiple concurrent auxiliary codes may be combined into one “combo-auxiliary code”. The execution of a single combo-auxiliary code may service multiple delinquent events. This may allow the elimination of common sub-expressions across different auxiliary codes in the combo-auxiliary code.

By default, the instruction sequence in an auxiliary code may be identical to the order of the counterpart instructions in the original binary. A compiler may also be used to reschedule instructions in auxiliary codes or across multiple auxiliary codes, e.g., by re-analyzing the data dependency relationships and producing a better schedule for the auxiliary code.

Seventh Example Embodiment

In a seventh example embodiment according to the present invention, an explicit new instruction may be included to specify the semantics of trigger instructions. For example, the semantics of trigger instruction invocation may be altered, e.g., by turning certain trigger instruction “on” or “off”. Control transfer semantics may also be altered, e.g., by changing what auxiliary code is invoked by a given trigger instruction. A legacy code may benefit from such architectural enhancements by “binary rewriting”.

Future architecturally visible enhancements such as explicit new instructions can be introduced by altering the trigger semantics of invocation and of control transfer. To benefit legacy codes from such architectural enhancement, a binary rewriting technique may be used to effectively overwrite the triggering instruction in the legacy code, place the new trigger instruction, and replicate the original trigger instruction into the trigger table. This rewriting scheme retains the original program semantics while allowing a new instruction to be introduced.

Eighth Example Embodiment

The triggering condition as defined by the trigger table may be flexibly defined and associated with each trigger in a programmable fashion. This may allow a post-compilation optimization mechanism, e.g., a continuous compiler, loader, runtime system, dynamic optimizer, hardware micro-architecture, to selectively turn on and off certain previously planned triggers.

A version-matching predicate may be provided. The version matching predicate may be used to ensure that a particular trigger and/or auxiliary code can only be invoked to do precomputation for a particular version of the micro-architecture.

Under different circumstances, for a particular delinquent operation of the trigger mechanism may be provided so that interest, multiple versions of the trigger table and auxiliary codes may co-exist. Only one version or subset of versions may be allowed to be invoked on a given hardware.

Modifications

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A method for executing a code, comprising:
receiving a trigger instruction;
selecting an entry in a trigger table, the entry associated with the trigger instruction; and
executing an auxiliary code referenced by the entry in the trigger table.

2. The method of claim 1, further comprising:
spawning a new thread, the new thread executing instructions included in the auxiliary code.

3. The method of claim 2, further comprising:
executing the new thread concurrently with a parent thread, the parent thread including the trigger instruction.

4. A method for executing a code, comprising:
receiving a trigger instruction;
selecting an entry in a trigger table, the entry associated with the trigger instruction; and
executing a p-slice code referenced by the entry in the trigger table.

5. The method of claim 4, further comprising:
spawning a new thread, the new thread executing instructions included in the p-slice code.

6. The method of claim 5, further comprising:
executing the new thread concurrently with a parent thread, the parent thread including the trigger instruction.

7. The method of claim 6, further comprising:
storing state information from the parent thread before spawning the new thread.

8. The method of claim 7, further comprising:
copying the state information for use in the new thread.

9. The method of claim 6, further comprising:
storing a register value of the parent thread before spawning the new thread.

10. The method of claim 9, further comprising:
copying the register value of the parent thread for use in the new thread.

11. The method of claim 4, wherein
the entry in the trigger table is selected by associative lookup of the trigger instruction.

12. The method of claim 4, further comprising:
reading an instruction pointer for the p-slice code from the entry in the trigger table.

13. An article of manufacture comprising a computer-readable medium having stored thereon instructions adapted to be executed by a processor, the instructions which, when executed, define a series of steps to be used to control a method for executing a code, said steps comprising:
receiving a trigger instruction;
selecting an entry in a trigger table, the entry associated with the trigger instruction; and
executing an auxiliary code referenced by the entry in the trigger table.

14. The article of manufacture of claim 13, wherein the series of steps further comprises:
spawning a new thread, the new thread executing instructions included in the auxiliary code.

15. A system, comprising:
a current thread;
a function body configured to be executed as part of the current thread, the function body comprising at least one trigger instruction;
an auxiliary code; and
a trigger table, the trigger table comprising an entry, the entry associated with the trigger instruction and including a reference to the auxiliary code, the trigger table configured to allow the lookup of the entry when the trigger instruction is processed.

16. The system of claim 15, wherein
the auxiliary code is configured to spawn a new thread when auxiliary code is executed.

17. The system of 16, wherein
the auxiliary code is configured to store the value of a register associated with the current thread, when the auxiliary code is executed.

18. A system, comprising:
a current thread;
a function body configured to be executed as part of the current thread, the function body comprising at least one trigger instruction;
a p-slice code; and
a trigger table, the trigger table comprising an entry, the entry associated with the trigger instruction and including a reference to the p-slice code, the trigger table configured to allow the lookup of the entry when the trigger instruction is processed.

19. The system of claim 18, wherein
the p-slice code is configured to spawn a new thread when the p-slice code is executed.

20. The system of claim 18, wherein
the p-slice code is configured to store the value of at least one register associated with the current thread, when the p-slice code is executed.

21. The system of claim 18, wherein
the trigger table is an associative lookup table.

22. A method for compiling, comprising:
receiving a function body, the function body comprising a trigger instruction;
outputting an auxiliary code associated with the function body and the trigger instruction; and
creating an entry in a trigger table, the entry associated with the trigger instruction and the auxiliary code.

23. The method for compiling of claim 22, further comprising:
creating a stub block, the stub block comprising a spawn instruction, the spawn instruction configured to spawn a new thread, the new thread configured to execute the auxiliary code.

24. A method for compiling, comprising:
receiving a function body, the function body comprising a trigger instruction;
outputting a p-slice code associated with the function body and the trigger instruction; and
creating an entry in a trigger table, the entry associated with the trigger instruction and the p-slice code.

25. The method of claim 24, further comprising:
receiving the p-slice code associated with the function body and the trigger instruction.

26. The method of claim 24, further comprising:
generating the p-slice code associated with the function body and the trigger instruction.

27. The method of claim 24, further comprising:
creating a stub block, the stub block comprising a spawn instruction, the spawn instruction configured to spawn a new thread, the new thread configured to execute the p-slice code.

28. The method of claim 27, further comprising:
adding store instructions to the stub block, the store instructions configured to store state information of a current thread, the state information of the current thread including values contained in live-in registers of the new thread.

29. An article of manufacture comprising a computer-readable medium having stored thereon instructions adapted to be executed by a processor, the instructions which, when executed, define a series of steps to be used to control a method for compiling, said steps comprising:
receiving a function body, the function body comprising a trigger instruction;
outputting an auxiliary code associated with the function body and the trigger instruction; and
creating an entry in a trigger table, the entry associated with the trigger instruction and the auxiliary code.

30. The article of manufacture of claim 29, wherein
the auxiliary code is a p-slice code.
